(19) United States
(12) Patent Application Publication
(10) Pub. No.: US 2005/0101029 A1
(43) Pub. Date: May 12, 2005

(54) Method and apparatus for precision changing of micropipettes

(76) Inventors: YunGui Tang, Petaluma, CA (US); Dale Gordon Flaming, Novato, CA (US); Richard Kellogg Ayer JR., Albany, CA (US); Jack Henrik Belgum, San Anselmo, CA (US); Frederick J. Siedenburg, Kentfield, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/703,281

(22) Filed: Nov. 7, 2003

(51) Int. Cl. B01L 3/02

(52) U.S. Cl. 436/183

(57) ABSTRACT

A semi-automated method of replacing micropipettes using a micromanipulator is disclosed. A first micropipette is moved at a known angle from a work position to a distal position under automatic control of the micromanipulator. A replacement micropipette is then mounted in the micromanipulator and is moved under automatic control to a position proximate to the work position. The distance between the work position and the proximate position is substantially equal to the range of manufacturing variability of the micropipettes. The second micropipette is then moved by manual control of the micromanipulator from the proximate position to the work position by moving it in a linear path along the known angle so that the final approach to the work position can be visually monitored.

### FIELD OF THE INVENTION

The present invention is directed to the use of micropipettes in scientific experimentation, and is particularly related to methods and apparatus for changing micropipettes to facilitate precise repositioning.

### BACKGROUND OF THE INVENTION

Micropipettes are used in a variety of scientific experiments, such as intracellular recording, cell patching, and the like, which require very precise positioning of the tip of the micropipette with the aid of an optical microscope. The micropipettes may be used to record electrical signals within a cell or within a cell membrane, or to apply a desired electrical stimulus to a cell. In such applications, the micropipette is typically positioned at a desired location under visual observation with a microscope, using a micromanipulator. To initially position or reposition a micropipette, the experimenter has to find its tip in the microscope's field of view by coarse movement of a micromanipulator aided by visual cues. Since the working distance and the field of view of commonly used microscope objectives are both very small, finding the tip of a pipette under the microscope is difficult and time consuming. In many experiments, it is often necessary to change micropipettes repeatedly.

Certain complex biological experiments make micropipette positioning and exchange even harder because other items (additional pipettes, perfusion tubes) may be placed near the pipette in a small space. In such cases, even with the utmost caution pipette tips can be broken. These factors make pipette exchange a frequent occurrence, while the procedure is simultaneously difficult and tedious. Automating this process as much as possible is highly desirable for experimenters and has become possible with the advent of motorized and microcontroller driven micromanipulators.

Exemplary micromanipulators currently in common use in the research community for precision control of the positioning of micropipettes are commercially available from Sutter Instrument Company, assignee of the present invention, under the designations Model MP-225 and Model MP-285. For example, the MP-225 provides programmability to automatically move a pipette to a “home” position or to a user-defined “work” position for quick location of the micropipette near to the recording location. Information about the MP-225 and MP-285 is available from the Sutter Instrument Company's “website” and in printed brochures. These materials are hereby incorporated by reference.

One approach to automated micropipette exchange is to repeat a previously recorded path into and out of the space under the microscope objective. Many motorized and micro-controlled micromanipulators, including the MP-225 have the ability to follow a programmed series of movements. The user can record a defined path and then re-execute it in either forward or reverse direction. Using such a programmable motorized manipulator it is easy to reposition the tip of an identical length pipette back to the same point in space under a microscope objective.

However, in practice it is quite difficult to automatically and precisely reposition micropipettes because of variability in pipette lengths. When manufactured by standard methods, pipette length varies to some degree. Most common methods produce pipettes that vary up to 1.5 mm over a total length of around 50 mm. Careful in-house manufacture of pipettes can perhaps reduce this variation down to around 0.50 mm. However, without extra quality control and/or manufacturing methods usually not found in the laboratory environment it is unlikely that the length of pipettes can be easily or inexpensively controlled with greater precision.

### SUMMARY OF THE INVENTION

Accordingly, it is an object of the present invention to provide a method and apparatus for precisely repositioning a micropipette at a desired location that takes into account manufacturing variability in the length of pipettes.

It is another object of the present invention to provide a method of using a programmable micromanipulator to facilitate the rapid and precise replacement and repositioning of micropipettes.

### BRIEF DESCRIPTION OF THE DRAWINGS

FIG. 1 is a schematic side view of a micromanipulator useful for practicing the present invention.

FIG. 2 is a schematic side view of an embodiment of the present invention showing the path of a micropipette during replacement.

FIG. 3 is a schematic top view of an embodiment of the present invention showing the path of a micropipette during replacement.

### DETAILED DESCRIPTION

The present invention relates to an apparatus and method of automated pipette repositioning that allows for the variability in the length of pipettes produced by standard methods. According to the invention, a “corrected path” is defined, comprising a set of movements that allows pipettes of controlled, but variable length to be repositioned in the field of view without causing broken pipette tips or damage to the biological specimen under investigation. Such a method is of value to the field as most experimenters will avoid using automated pipette repositioning if it might risk damage to the preparation or the pipette. In a preferred embodiment the present invention defines the corrected path and its implementation using a programmable motorized micro-manipulator.

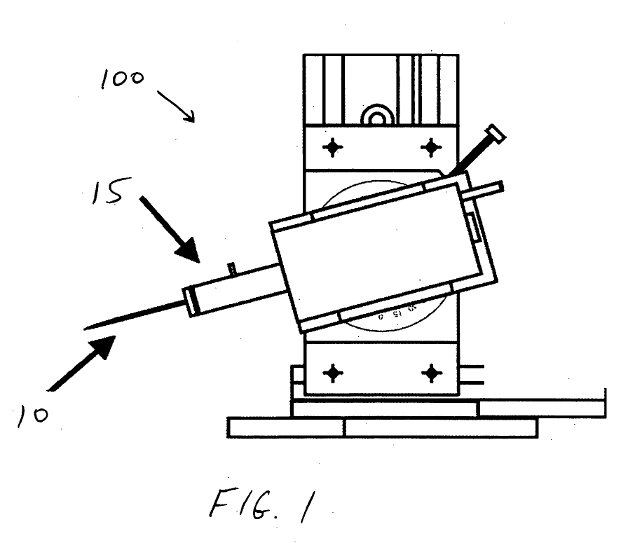

The present invention comprises a micromanipulator and a method of using the micromanipulator. FIG. 1 shows a micromanipulator 100 having a pipette holder 15 in which a micropipette 10 is positioned. Micromanipulator 100 comprises a programmable motorized control system which enables a user to precisely move the micropipette in three axes. Preferably the control system enables the user to enter program information to precisely control the movements of the micropipette, to record positional information, and to record a path followed by the pipette so that it can be subsequently replicated. In addition, micromanipulator 100 allows direct, non-programmed user control over the movement and positioning of the micropipette. In actuality micromanipulator 100 directly controls the positioning of the micropipette holder, not the micropipette. Therefore, the ability to precisely replicate the positioning of variable length micropipettes is limited by the manufacturing variability of the micropipettes as described above.

A suitable micromanipulator for practicing the present invention is the model MP-225 Motorized Micromanipulator made by Sutter Instruments Company of Novato Calif., assignee of the present invention. In the exemplary MP-225 micromanipulator, positioning of holder 15 can be controlled to within less than a tenth of a micron.

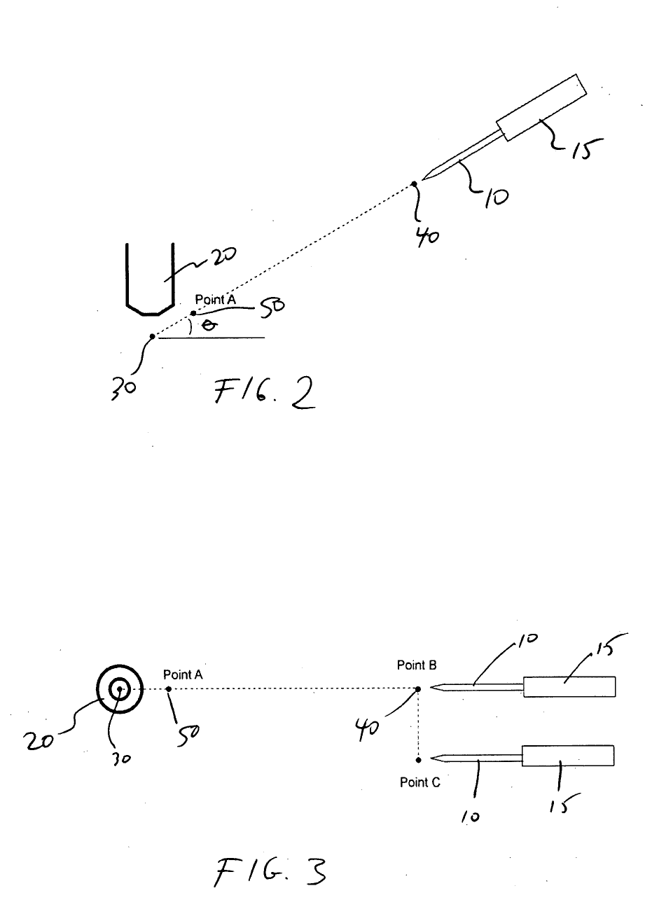

Turning to FIGS. 2 and 3, according to the present invention, the angle of a first micropipette 10 as it is positioned in a micropipette holder 15 of micromanipulator 100 is determined. The angle may be determined with respect to any convenient reference line, for example either the horizontal or vertical axis of the micromanipulator. In FIG. 2, the angle θ is depicted in reference to the horizontal axis. The angle can be determined by the user or may automatically be recorded by the control system of micromanipulator 100. Preferably, the micromanipulator automatically senses the angle of the micropipette holder and, thereby, the angle of the micropipette. The angle θ is stored in memory of the micromanipulator's controller as the first step in defining the corrected path of the present invention.

The user then positions the first micropipette under microscope objective 20 at a point 30 that is near or touching the specimen, herein defined as the “work position”. In some cases, the angle may need to be adjusted to correctly place the pipette tip at the work position. If adjustment is necessary, the value of the angle θ is updated in the controller. At this point the first micropipette is ready for use.

As contemplated by the present invention, eventually it will become necessary to replace the first micropipette. Replacement might be required for any of a number of reasons. When replacement is needed, the first micropipette is withdrawn along the line defined by angle θ, away from the specimen and out from under the microscope objective 20 to point B, 40. Preferably, Point B is at the end of the micromanipulator's range of motion, so that the first micropipette is as far as possible from the work position, thereby providing a clear working area for micropipette exchange. In one embodiment, the distance of retraction is determined and is entered into the controller of the micromanipulator. The distance d may be determined automatically by the micromanipulator by recording the withdrawal of the micropipette.

When Point B is reached the user may then replace the first micropipette with a second micropipette. Alternatively, the micromanipulator holder may be further moved to a Point C, as shown in FIG. 2, if additional clearance is required to facilitate replacement. Movement between Point B and Point C may be manual or automated. Manual movement is less of a concern when the micropipette is removed from the work area.

After replacement the micropipette, is at, or is returned to Point B. Note that due to variability in the micropipettes, the tip of the second micropipette may not be exactly at Point B, but micropipette holder 15 will be at precisely the same position it was in when the tip of the first micropipette was at point B.

The user then defines a position 50 (Point A) along the path as the end point for automated returning. The distance between Point A and the work position, Δd, is set to be equal to or slightly more than the range of variation of pipette length. The range of variation is dependent on the techniques used to fabricate pipettes, but can easily be maintained at less than 2 mm. Thus, when the range of variation is 2 mm, Δd=2 mm and, for the first micropipette, Point A is separated from Point B by a distance d−Δd.

In one embodiment of the present invention, the micromanipulator is capable of recording path and distance information which can be used to implement the present invention. The aforementioned MP-225 micromanipulator allows the user to manually start the recording process. Thus, when using this device the user can simply start the recording after the first micropipette has moved a distance equal to Δd.

Micromanipulator 100 then uses the stored information to return the micropipette along a linear path defined by the angle θ to a position corresponding to Point A. For the second and subsequent micropipettes, upon return the tip of the micropipette may not be located exactly at Point A and could, in fact, vary from Point A by as much as Δd. Again, micropipette holder 15 will be returned to exactly the same position. Therefore, for convenience, reference to returning the second micropipette to Point A is intended to mean returning the micromanipulator holder to the calculated location for positioning the first micropipette at Point A.

After returning the micromanipulator to Point A, the user manually controls the micromanipulator to move the second micropipette along the line defined by angle θ until it reaches the work position. Prior to reaching the work position, the tip of the second micropipette enters the field of view of the microscope, such that the final approach to the work position can be visually monitored. As long as the micropipette is moved at the angle θ, the tip of the second micropipette will intersect the work position. It will be appreciated that the if the first micropipette is at or near the short end of the range of variability and the second micropipette is at the long end of the range, then the tip of the second micropipette will be located at or near the work position when the micromanipulator returns to Point A.

Operation of the programmable micromanipulator in this fashion greatly simplifies the search for the tip of a pipette because one knows that the tip will show up on the diagonal line regardless of its variable length and can therefore be easily found under the microscope. In addition, the short distance between the work position and Point A greatly reduces the distance of manual control of the micromanipulator.

In accordance with the preferred embodiment of the present invention, movement of the second micropipette from Point B to Point A is along a linear path at angle 0. It will be appreciated that any other path between these two points may be followed, so long as the second micropipette is oriented at the angle 0 when it is at Point B.

While the present invention has been particularly described with respect to the illustrated embodiments, various alterations, modifications and adaptations may be made based on the present disclosure, and are intended to be within the scope of the present invention. While the invention has been described in connection with what is presently considered to be the most practical and preferred embodiments, it is to be understood that the present invention is not limited to the disclosed embodiments but, on the contrary, is intended to cover various modifications and equivalent arrangements included within the scope of the appended claims.

1. A method of replacing a first micropipette with a second micropipette, said first and second micropipettes being manufactured by a method which result in variability in the length within a known range, comprising:
positioning the first micropipette at a work position at a work angle, withdrawing the first micropipette to a position distal from said work position, replacing said first micropipette with the second micropipette, thereafter, moving said second micropipette under automatic control to a position proximate said work position, the distance between said proximate position and said work position being substantially equal to the range of manufacturing variability in the length of the said micropipettes, thereafter, manually adjusting the position of said second micropipette by linear movement along said work angle to bring the tip of said second micropipette to said work position.

2. The method of claim 1 wherein the movements of said first and second micropipettes are controlled by a micromanipulator.

3. The method of claim 2 wherein said micromanipulator is programmable.

4. The method of claim 3 wherein said micromanipulator automatically determines the work angle.

5. The method of claim 3 wherein said micromanipulator automatically determines the distance between said distal position and said work position.

6. The method of claim 1 wherein said second micropipette is moved to said proximate position along a linear path defined by said work angle.

7. The method of claim 1 wherein the range of manufacturing variability is 2 mm or less.

8. The method of claim 1 wherein the range of manufacturing variability is 0.5 mm or less.

9. A method of using a programmable micromanipulator having a micropipette holder for precisely positioning micropipettes of variable length, comprising:
mounting a first micropipette in said micropipette holder, positioning said first micropipette at a work position, determining the angle of said micropipette after it has been positioned at said work position,
withdrawing said first micropipette to a position distal from said work position,
replacing said first micropipette with a second micropipette,
moving said second micropipette to a position proximate said work position under automatic control of said micromanipulator,
thereafter manually controlling said micromanipulator to move said second micropipette from said proximate position to said work position along a linear path defined by said angle.

10. The method of claim 9 wherein the tip of a micropipette located at said work position is observable in a microscope.

11. The method of claim 9 wherein said angle is automatically determined by said micromanipulator.

12. The method of claim 9 wherein said distal position is at the limit of the range of motion of said micromanipulator.
